(19) United States
(12) Patent Application Publication
(10) Pub. No.: US 2007/0022468 A1
(43) Pub. Date: Jan. 25, 2007

(54) Packet transmission equipment and packet transmission system

(75) Inventors: Tomoyuki Iijima, Kawasaki (JP); Kenichi Sakamoto, Kokubunji (JP); Kunihiko Toumura, Hachioji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/455,804

(22) Filed: Jun. 20, 2006

(30) Foreign Application Priority Data
Jun. 23, 2005 (JP) 2005-182773

(51) Int. Cl. H04L 9/32

(52) U.S. Cl. 726/3

(57) ABSTRACT

Traffic flowing through packet transmission equipment comes in countless variations ranging from traffic from harmless general users, to PC virus-infected users, and users with harmful intent. Transferring all of this traffic together through a module for monitoring causes a great loss in throughput and is an extremely inefficient way to handle general user traffic. After checking the module processing results, the system administrator can resolve this situation by changing each user's transfer module but making this setting manually is unwieldy and lacks flexibility. A security level can be set on table in the platform module linking each user to the destination application module. By dynamically changing this security level according to processing results in each module, each user's destination application module can be changed smoothly and flexibly.

### CLAIM OF PRIORITY

The present application claims priority from Japanese application JP 2005-182773 filed on Jun. 23, 2005, the content of which is hereby incorporated by reference into this application.

### FIELD OF THE INVENTION

The present invention relates to packet transmission equipment for dynamically changing the user security level according to the type of traffic sent by the user, and changing the destination application module.

### BACKGROUND OF THE INVENTION

Firewalls (FW) and intrusion detection systems (IDS) have been installed in user and company computers for some time now. However the increasing proliferation of users and Internet layers is making it increasingly difficult for these FW and IDS functions to fulfill the goals set for them by companies and individual users. Currently these functions are provided by the packet transmission equipment in a structure where companies and users are not aware of these FW and IDS functions. There are two methods for using FW and IDS functions via packet transmission equipment for use on IP networks. In one method, these FW and IDS functions are incorporated into the packet transmission equipment as modules. In the other method, these FW and IDS functions are provided via outside equipment connected to the packet transmission equipment. FIG. 1 shows the FW and IDS functions incorporated into the packet transmission equipment as an FW module and IDS module. FIG. 3 shows the internal structure of the packet transmission equipment 11. FIG. 2 shows the FW and IDS functions provided as outside equipment connected to the packet transmission equipment.

The FW (or firewall) is a function intended to prevent intrusion into an organization's computer from an outside source, or to prevent a computer within an organization from wrongfully accessing a potentially dangerous website. The IDS (or intrusion detection system) is a function to analyze packets flowing along networks and inform the administrator if an unauthorized intrusion is detected. The method to detect unauthorized intrusions works by storing frequently used illegal access techniques and then comparing these unauthorized (wrong) patterns with actual packets to decide if unauthorized intrusion or access is being attempted.

Packets sent from the user to the packet transmission equipment are usually searched (or indexed) by the packet transmission equipment and then transferred to the desired destination. If this packet transmission equipment incorporates an FW module and IDS module and if there is a platform module as shown in FIG. 3, to assign packets to these modules, then the platform module can forward these packets for unique processing in each module. Moreover if the platform module as shown in FIG. 3 contains a user identification module for identifying the user, and a user-destination module table for matching the destination application module with the user; then the destination application module can be changed to match the user.

### SUMMARY OF THE INVENTION

Unlike packet transmission equipment that generally handle a heavy processing load and merely transfer a packet to the next destination, the FW and IDS modules are characterized by a small throughput. Processing all traffic from the packet transmission equipment through the IDS and FW modules therefore limits the overall throughput to that of the IDS or FW throughput.

Transferring packets to these modules and processing them also increases the transfer and processing time by an equivalent amount. In other words, the greater the effort to maintain security, the longer the transfer and processing time becomes. Conversely, adequate security cannot be maintained if priority is given to the transfer and processing time.

Traffic flowing through packet transmission equipment comes in countless variations ranging from traffic from harmless general users, PC virus-infected users and to users with harmful intent. Transferring all of this traffic together through a module for monitoring causes a great loss in throughput and is an extremely inefficient way to handle harmless general user traffic. After checking processing results from each module, the system administrator can resolve this situation by changing each user's transfer module but this method is troublesome since it requires manually making settings to detect illegal access. Moreover, once an illegal access is detected, time is needed for the administrator to acknowledge the problem and make new settings so this method lacks flexibility.

The security level can be set in the table within the platform module that matches the application module and user. Using the processing results from the module to dynamically change the security level allows making flexible changes to each user's destination application module.

More specifically, harmless general user traffic is not sent to the application module, and priority is given to a high throughput. However, packets are periodically sampled and processed by the module. If results show the packet might be carrying a virus or potentially harmful traffic is being sent then that user's security level is raised and set in the table. The destination application module is in this way changed and only highly dangerous traffic is transferred to a module for secure processing.

Packet transmission is highly efficient since minimal delay packet transfer is provided to those users not likely to prove harmful, while traffic from those users with harmful intent is transferred to a module for secure processing.

### BRIEF DESCRIPTION OF THE DRAWINGS

FIG. 1 is a block diagram showing the network structure including the FW module and the IDS module of the packet transmission equipment of this invention;

FIG. 2 is a block diagram showing the network structure when the FW and IDS modules are connected as outside equipment to the packet transmission equipment of this invention;

FIG. 3 is a drawing showing the traditional packet transmission equipment.

FIG. 4 is a drawing showing the packet transmission equipment of this invention;

FIG. 5 is a table in which are written the user security levels held by the platform module within the packet transmission equipment of this invention;

FIG. 6 is a table linking the transmit application modules and the security levels within the platform module within the packet transmission equipment of this invention;

FIG. 7 is drawing showing the internal header for the packet exchanged within the packet transmission equipment of this invention;

FIG. 8 is a drawing showing the original header of FIG. 7 for the first embodiment;

FIG. 9 is a drawing showing the original header of FIG. 7 for the second embodiment;

FIG. 10 is a drawing showing the packet exchange within the packet transmission equipment of the first embodiment when the application module decides the sample packet is normal;

FIG. 11 is a drawing showing the packet exchange within the packet transmission equipment of the first embodiment when the application module decides the sample packet is abnormal;

FIG. 12 is a flowchart showing the process within the application module in the packet transmission equipment of this invention.

### DETAILED DESCRIPTION OF THE PREFERRED EMBODIMENTS

### First Embodiment

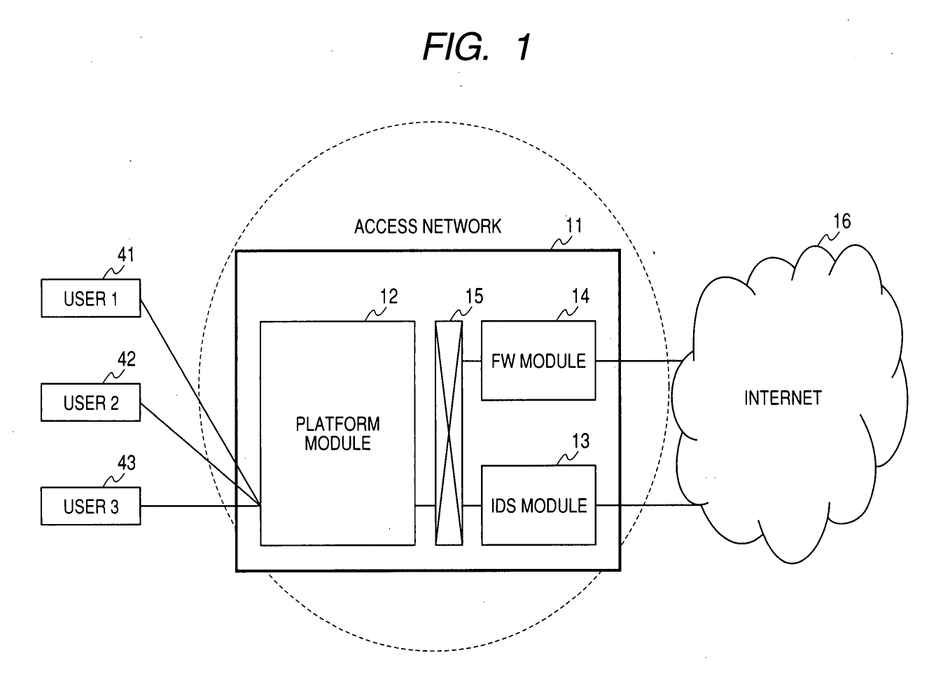

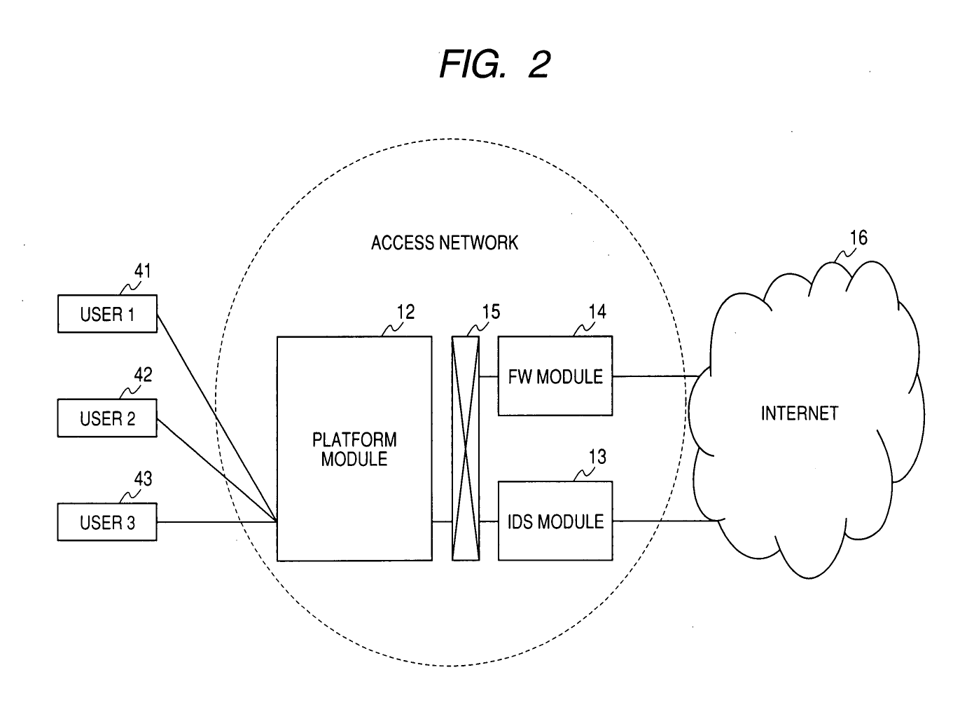

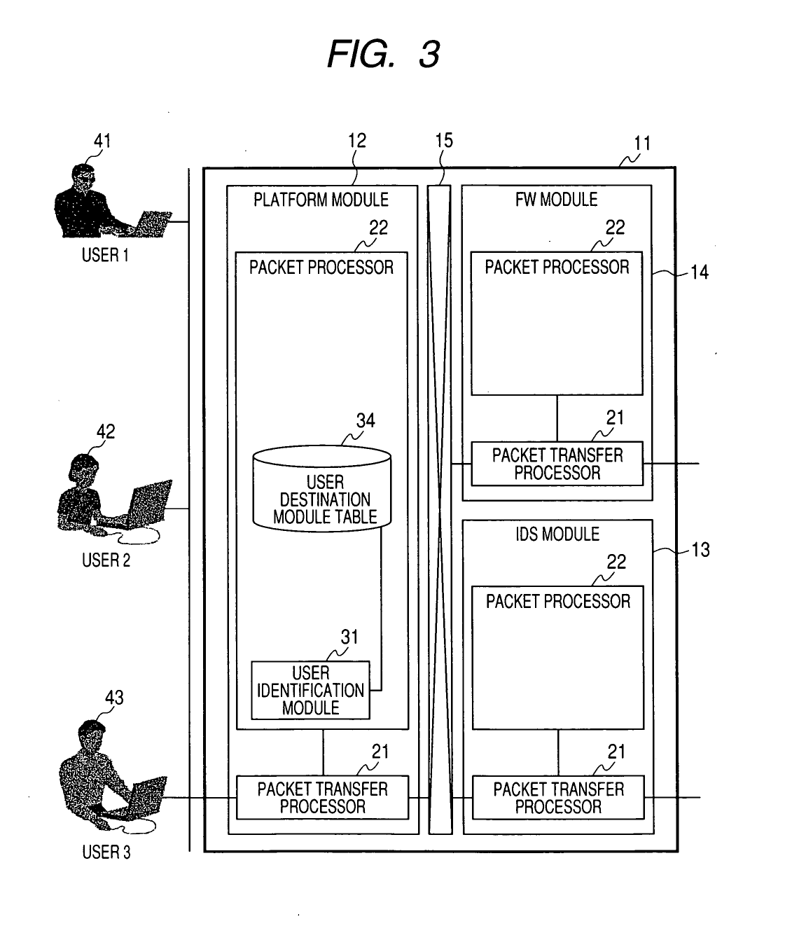

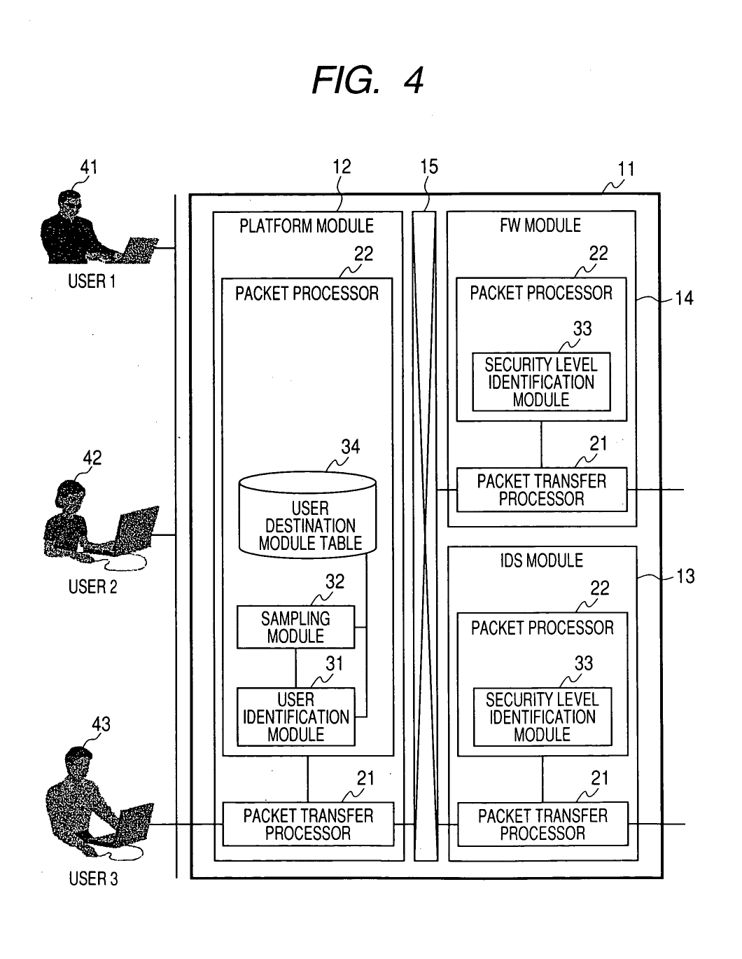

FIG. 4 is a diagram showing the internal structure of the packet transmission equipment of this embodiment when containing the FW and IDS functions as shown in FIG. 1, as an FW module and an IDS module. After receiving a packet from the user via the packet transfer processor 21, the platform module 12 transfers that packet to the user identification module 31 and verifies the user sending that packet.

The user destination module table 34 within the packet processor 22 contains the table in FIG. 5 recording the link between the user and security level, and the table shown in FIG. 6 recording the link between the security level and transfer module. Here, the lower the security level value, the stronger the security. The security level 1 for user 1 is the highest level of security, and the FW module and IDS module are set as its destination application module. The security level 1 is mainly for those users sending harmful traffic. A security level 2 is set for user 2 and the FW module is set as its destination application module. This security level 2 is usually assigned to users sending unusual traffic whose results show contamination such as from a virus. The security level 3 for the user 3 does not use module transfer. Traffic at security level 3 is sent directly from the platform module to an outside network. This security level is for general users and is intended only for high-speed packet transmission.

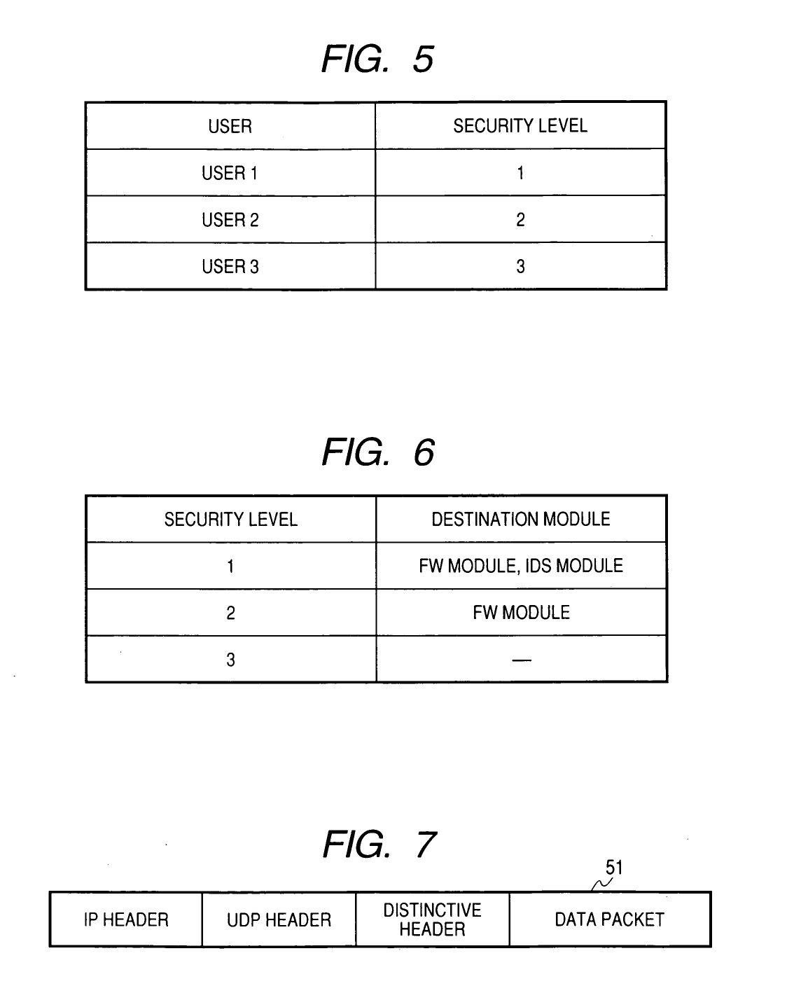

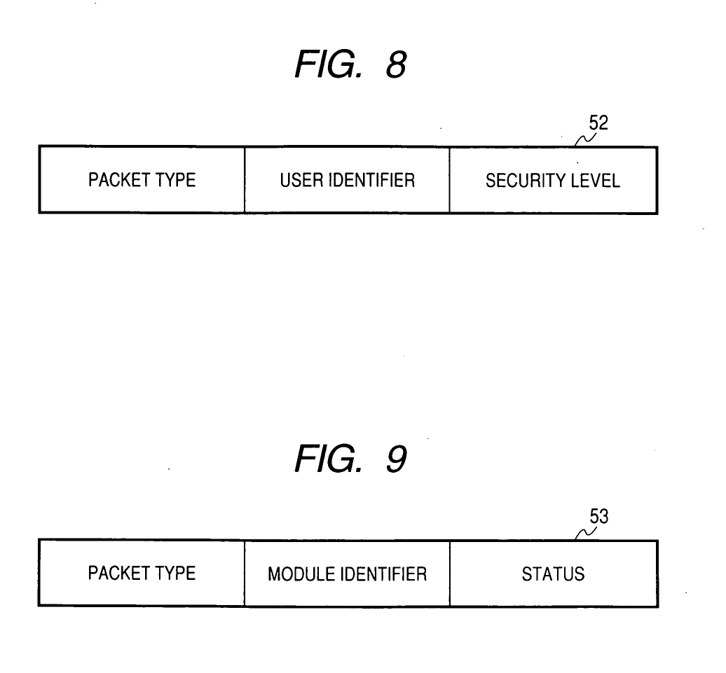

The user identification module 31 in FIG. 4 recognizes the destination application module for traffic from each user by referring to the tables in FIG. 5 and FIG. 6. The user identification module 31 then attaches an internal header to the packet and as shown in FIG. 7 and encapsulates it in order to send that packet to the matching module. The internal header is made up of an IP header, a UDP header, and an original header. The format of the original header is shown in FIG. 8. The original header is made up of a packet type field, a user identifier field, and a security level field. The IP address for the (transfer) destination application module is written in the destination address field contained in the IP header of FIG. 7. In FIG. 8, the data packet or sample packet or control packet (as the type) is written in the packet type field; an identifier for recognizing the user is written in the user identifier field; and the current security level of that user is written in that security level field.

The packet transfer processor 21 sends the packet affixed with a header by the user identification module 31 in FIG. 4, to the desired application module by means of the destination IP address within the internal header. After arriving at the packet transfer processor 21 within the application module, the packet is transferred to the packet processor 22 and uniquely processed by that section of each application module. After removing the internal header of the processed packet, it is sent to the packet transfer processor 21. The destination of the packet that arrived at the packet transfer processor 21 is recognized by means of its destination IP address, and the packet is then sent to the outside network.

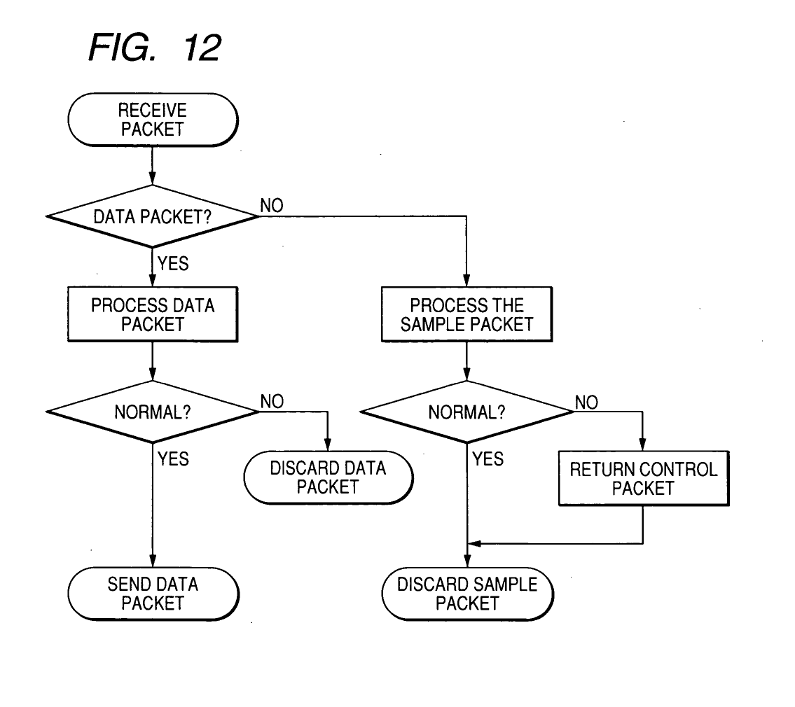

In the above process, when for example the (transmit source) sender of the packet sent from the user 3 is recognized via the user identification module 31 within the platform module, the security level in FIG. 5 is 3 and that packet is judged as not from the transfer application module of FIG. 6. This packet is therefore then transferred to the outside network without transiting through the application module. The packet from the user 2 is security level 2 and its transfer (destination) application module is judged to be an FW module. This packet therefore contains an IP address and data packet so an internal header listing the user identifier and security level 2 is attached to it and it is then transferred to the FW module. After processing the packet in the FW module, the internal header is removed as shown in the flow chart of FIG. 12 if found to be normal and the packet is sent to an outside network. However if determined to be unauthorized (suspicious) traffic, then that packet is discarded. Packets from the user 1 are sent via the FW module and IDS module to the outside network in the same way.

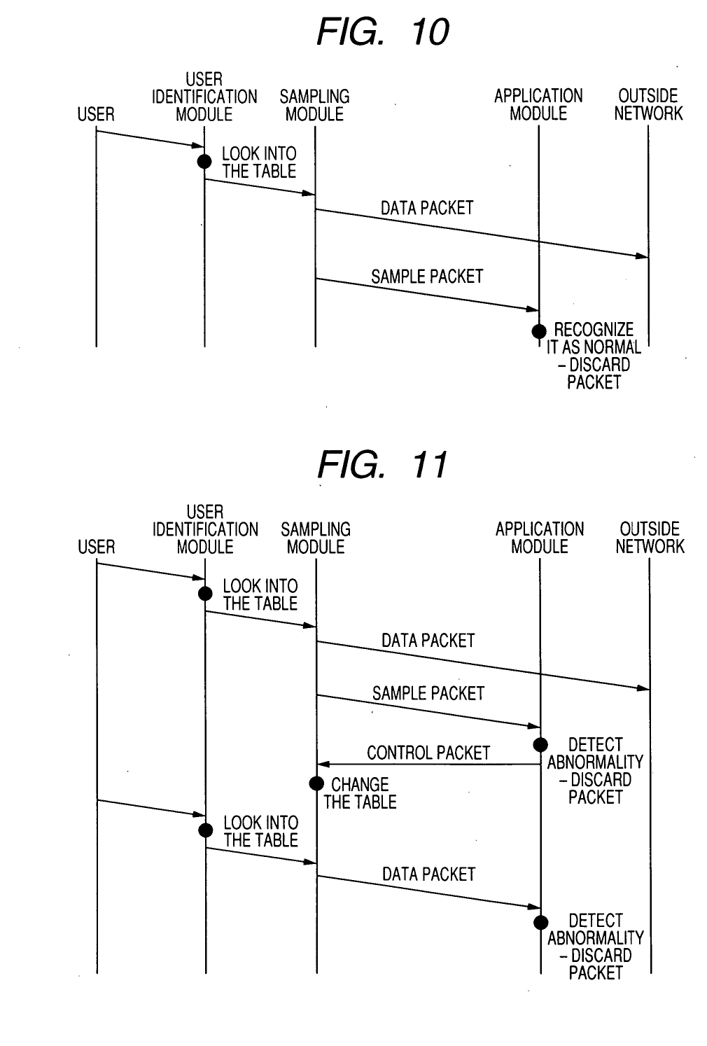

The sampling module 32 here periodically copies packets that arrived from the user identification module for use as sampling packets, and transfers them to a destination application module that is 1 stage higher than the current security level. In the case of user 3, the current security level is 3 so if raised to security level 2 then that sampling packet is sent to the transfer module or in other words the FW module. The packet type of the internal header is written (listed) as sample data. The packet processor 22 applies the FW function to that transferred packet. If there are no particular abnormalities in the results from applying the FW function, then that sampling packet is discarded as shown in FIG. 10. However if the sample packet of the user 3 for example contains a URL (Uniform Resource Locator) that was registered beforehand in the FW module as a suspicious URL, then the FW module decides that this traffic is unauthorized (suspicious) traffic. If decided to be an unauthorized access then the FW module discards the sample packet as shown in FIG. 11, and sends a control message to the platform module to change the security level from 3 to 2. The format for the control message at that time is the same as in FIG. 7 unless there is a data field. The packet type specified in the original header is utilized to recognize the control message. The security level field within the original header stores the new value after changing the security level. The sampling module within the platform module receives the control message. After receiving the control message, the sampling module changes the security level in the destination table. The security level of the user 3 is from this point on changed to 2 in this way, and all traffic from the user 3 is sent to the FW module and is monitored by the FW module. Packets in the traffic sent from user 3 judged to be suspicious (unauthorized) by the FW module are thereafter discarded. Normal traffic however is sent to the outside network.

The sampling unit 32 of FIG. 4 also periodically copies the sample data, and continues packet transfer to the module. The security level has shifted to 2 so the sampling packets are transferred to the FW module and IDS modules that serve as the destination module if the security level hereafter shifts to 1. If there are no abnormalities in the results from IDS processing in the IDS module, then the packet is discarded as shown in FIG. 10. However if the sample packet of the user 3 for example contains an illegal command (signature) that was registered beforehand in the IDS module as command not normally used, then the IDS module decides that this traffic is unauthorized (suspicious) traffic. If determined to be an unauthorized access then the IDS module sends a control message to the platform module to change the security level of the user 3 from 2 to 1 as shown in FIG. 11. The sampling module within the platform module receives the control message and changes the value in the table. All traffic from the user 3 is from hereon sent to the FW module and IDS module, and is monitored by the FW module and IDS module. Packets among the traffic sent from the user 3 that the FW module or IDS module decide are unauthorized packets are discarded. Normal traffic however is sent to the outside network.

Packets from typical harmless users are therefore sent by normally light load packet transmission, and the security level is gradually raised only in cases where there is potential danger to allow highly efficient packet transmission by provided reliable module processing.

Once a user is placed under application module observation, countermeasures such as virus disinfecting are implemented. When the safety of the traffic has been restored, then that user's security level must be lowered to return to normal status. The application module therefore makes a count of the total number of errors (abnormalities) occurring within a fixed period of time. If no abnormalities were detected within that fixed period of time then the application module returns the security level to the original level. The current IDS module and FW module for example monitor traffic from the user 3 and if no abnormal results are found after monitoring for instance for one hour, then the IDS module sends a control message to the platform module to return the user 3 security level from 1 to 2. The sampling module in the platform receives the control message and changes the table value. The traffic from the user 3 is in this way only transmitted via the FW module from hereon. The FW module also monitor the traffic for a one hour period and likewise if no abnormalities were found in the results then the FW module, sends a control message to the platform module to change the user 3 security level from 2 to 3. The sampling module in the platform receives the control message and changes the table value. The user 3 is in this way judged to be a harmless user and no module transmission is performed from then onwards.

The destination application module can in this way be flexibly changed according to the degree of danger in the traffic.

### Second Embodiment

The type and number of application modules linked to the platform module is found via the sampling module 32 in FIG. 4. This information is found by sending a control packet containing the original header in FIG. 7 holding the “Packet type”, “Module identifier” and “Status” information shown in FIG. 9. The module identifier for the module including the module type to be sent in the control packet is shown in the module identifier field in FIG. 9. The status field in the same figure indicates the state of that module. The control message allows the platform module to initiate an action according to the status of the application module. For example, when the processing load on the IDS module exceeds the threshold value and packets sent from the platform module can no longer be processed, then a message “Overload” can be written in the status field in FIG. 9 and the platform module is then notified by means of the control message in FIG. 7. The platform module that received the control message then notifies the administrator to add a new IDS module or to widen the transfer period of the sample packet to reduce the traffic transmission load per unit of time. Moreover, when a new IDS module is connected to the platform module, the message “New Addition” is written in the status field in FIG. 9 and the platform module is notified via a control message. The platform module receives that control message, sets a narrow transmit period for the sample packets, and increases the traffic load per unit of time.

This invention can therefore flexibly change the packet load sent from the platform module to the application module, according to transitions in the state of the application module.

What is claimed is:

1. Packet transmission equipment including a platform module, and multiple application modules and a packet receiver and a packet transmitter,
the platform module comprising:
a packet transfer processor for transferring packets input from the packet receiver to the application module or the packet transmitter, and
a user identification module for identifying the sender (user) of the received packet, and
a memory for storing according to the user, one or multiple application modules as the destination for the packet sent from the user, as well as security levels for the corresponding users, wherein
the application module includes:
a packet transfer processor for transferring packets to the platform module, other application modules, or a packet transmitter, and
a security level identification module for identifying the security level of the packet that was transferred, and
a packet processor for processing the packet that was transferred.

2. Packet transmission equipment according to claim 1, wherein
the platform module copies a portion of the multiple packets that were input, and transfers the copied packets to any of the multiple application modules.

3. Packet transmission system including multiple application equipment, and packet transmission equipment including a platform module and a packet receiver and a packet transmitter, connected to the multiple application equipment,
the platform module for the packet transmission equipment comprising:
a packet transfer processor for transferring packets input from the packet receiver to the application equipment or the packet transmitter, and
a user identification module for identifying the sender of the received packet, and
a memory for storing according to the user, one or multiple application equipment as the destination for the packet sent from the user, as well as security levels for the corresponding users, wherein
the application equipment includes:
a packet transfer processor for transferring packets to the platform module, other application equipment, or a packet transmitter, and
a security level identification module for identifying the security level of the packet that was transferred, and
a packet processor for processing the packet that was transferred.

4. Packet transmission system according to claim 3, wherein
the platform module also copies a portion of the multiple packets that were input, and transfers the copied packets to any of the multiple application equipment.

5. Packet transmission equipment according to claim 1, wherein
a search is made of the information in the memory of the platform module, to determine the application module serving as the packet destination for each user sending a packet.

6. Packet transmission equipment according to claim 1, wherein
instead of storing according to the user, one or multiple application modules destinations for the packet sent from the user, as well as security levels for the corresponding users,
the memory in the platform module stores according to the input port, one or multiple application module destinations for packets input from the port, and the security levels for that port, and a search is made of information within the memory to determine the application module serving as the packet destination for each port.

7. Packet transmission system according to claim 3, wherein
a search is made of information within the memory inside the platform module to determine the application equipment serving as the packet destination for each packet sender.

8. Packet transmission system according to claim 3, wherein
instead of storing according to the user, one or multiple application equipment destinations for packets sent from the users, as well as security levels for the corresponding users,
the memory in the platform module stores according to the input port, one or multiple application destinations for packets input from the port, and the security levels for that port, and a search is made of information within the memory to determine the application equipment serving as the packet destination for each port.

9. Packet transmission equipment according to claim 1, for sending a control message to the platform module from the application module, to change the information within the memory in the platform module based on that control message.

10. Packet transmission system according to claim 3, for sending a control message from the application/network equipment to the platform module, to change the information within the memory of the platform module based on that control message.

11. Packet transmission equipment according to claim 2, wherein a control message is sent from the application module to the platform module, to request increasing or decreasing the modules based on that control message, or to change the extent of packet copying by the sampling module.
